(19) United States
(12) Patent Application Publication
(10) Pub. No.: US 2011/0127686 A1
(43) Pub. Date: Jun. 2, 2011

(54) THERMOFORMER

(76) Inventor: Mohssen BEHRAD, Burnaby (CA)

(21) Appl. No.: 12/954,772

(22) Filed: Nov. 26, 2010

(30) Foreign Application Priority Data
Nov. 30, 2009 (CA) 2686153

(51) Int. Cl. A61C 13/34; A61C 9/00

(52) U.S. Cl. 264/16; 249/54

(57) ABSTRACT

There is provided an automatic thermoformer for dental and other prosthetic devices, that operates vertically on a blank, without operator manipulation thereof.

### FIELD OF THE INVENTION

This invention relates to plastic thermoforming.

### BACKGROUND OF THE INVENTION

The invention addresses the limitations over current thermoforming equipment for forming dental parts (such as waxing copings, transfer copings, full models of the teeth or mouth, tooth guards, orthodontic appliances and other thermal-formable dental items). In the past operators or dental technicians had to remain with the equipment to observe the melting of the materials and manually process the materials. Given the variety of materials, individual differences in time assessment and visual comparatives, the results were varied and often unsatisfactory.

There are many devices for molding or forming dental parts such as waxing copings, transfer copings, full models of the teeth or mouth, teeth guards, orthodontic appliances and other thermal-formable dental items. Previously, the operator positioned a heater over a plastic disk holder, employed the heater and timed the heating, and then moved the heater away. Then a pressure device was connected to the blank holder to force it into contact with a working model or dies. The softened blank was positioned over the model and the heater moved away from heating the disk. The heating and flipping manually of laminates, added extra time and steps to processing. Next, a manual movement of the disk into contact with the model and pressure applied for the molding operation. The operator then had to wait sufficient time for the unit to cool before disengaging and removing the model and the now formed pre-appliance.

U.S. Pat. No. 4,798,534 is typical of prior attempts. The retaining material is hingedly rotated into position for impressing on the die. One defect is that if the material is a “dual laminate”, the material must be first heated on the soft side, manually flipped and heated on the other, hard side before being rotated into position for impressing on the die.

### SUMMARY OF THE INVENTION

There is provided a device for thermoforming dental and like models, comprising: a) a base on which the model is placed; b) a thermoplastic blank; c) a platform that holds said blank and is suspended in a first position; d) a heater that moves above said blank to heat said blank, and then moves away; e) a vertical chamber that moves downwardly to engage said blank on said tray and the engages said base to form an air-tight chamber; and f) forced air source connected to said air-tight chamber.

### BRIEF DESCRIPTION OF THE DRAWINGS

A better understanding of the present invention can be obtained when the following detailed description of the preferred embodiment is considered in conjunction with the following drawings, in which:

FIG. 1a is a perspective partial front view of the thermoforming device;

FIG. 1b is another perspective front view of the thermoforming device;

FIG. 2 is a side section view of the chamber base;

FIG. 3 is a side section view of the chamber cover;

FIG. 4 is a plan view of the retaining material tray;

FIG. 5 is a plan view of the carriage for the tray of FIG. 4;

FIG. 6 is a side section view of the screw jack with an amplified view of the bearings;

FIG. 7 is a partial side view of a vacuum-based embodiment;

FIG. 8 is a view of the selection guide-chart; and

FIG. 9 is a side view of another embodiment.

### DETAILED DESCRIPTION OF THE PREFERRED EMBODIMENT

### Notice Regarding Copyrighted Material

A portion of the disclosure of this patent document contains material which is subject to copyright protection. The copyright owner has no objection to the facsimile reproduction by anyone of the patent document or the patent disclosure as it appears in the Patent and Trademark Office file or records, but otherwise reserves all copyright rights whatsoever.

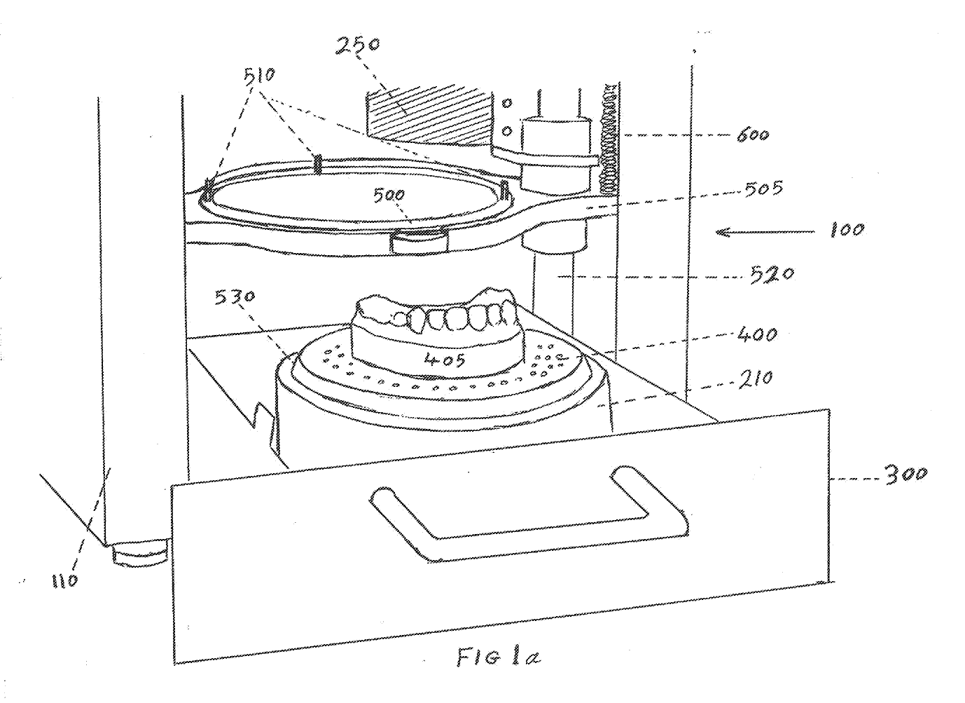

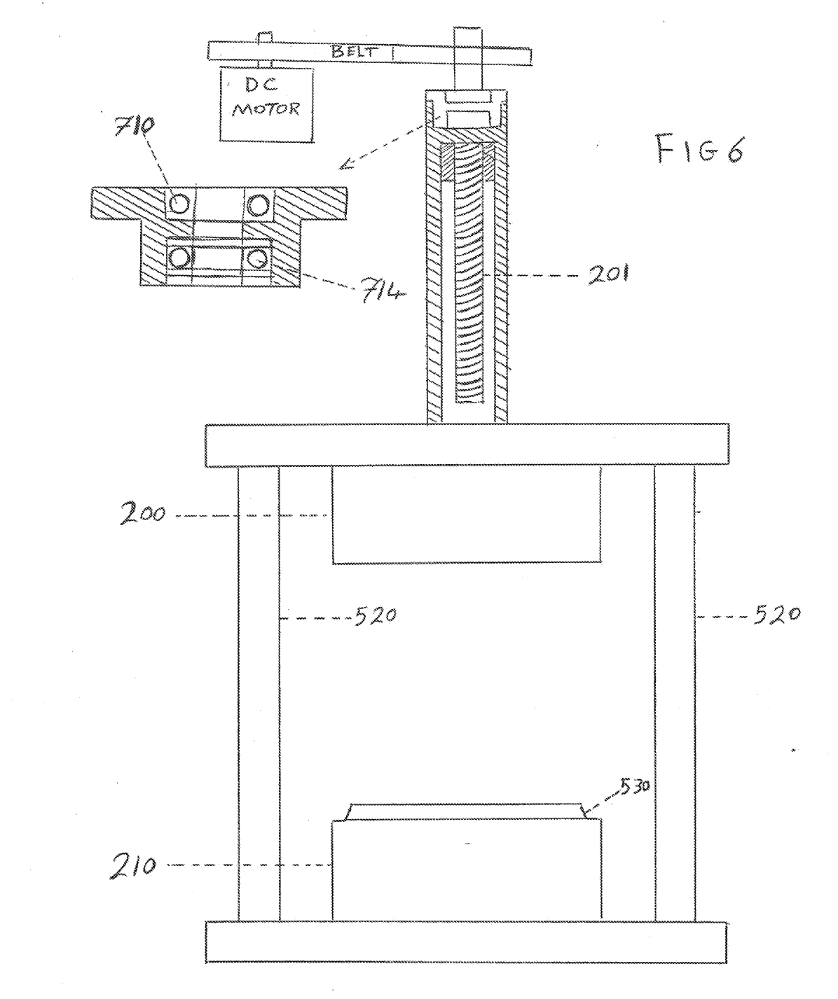

As seen in FIG. 1, thermoformer 100 is housed entirely in metallic cabinet or housing 110. Thermoformer 100 has a central vertical axis and a corresponding columnar space where the main activity of the present invention is carried out, as explained below. As seen in FIGS. 1 and 6, plunger 201, cover 200, tray 500 and carriage 505 are movable axially vertically along the main central axis, whereas work table 400 and model 405 are centered on that main central axis but are rigidly orientated.

Housing 110 has a conventional user interface that can include a plurality of conventional components, such as a keyboard for inputting data and/or instructions, control dials and buttons, and visual displays. But as shown in FIG. 1, it suffices for one embodiment of the present invention that the user interface be minimal with a single control dial 111 (for inputting and selecting the duration of thermoforming steps, as explained below, and which also may have a conventional combination push/pull power control feature) and associated some visual/aural indicators for the operator (e.g. bell or green/red lights). The user interface can be integral with housing 110 or be part of a separate unit in communication with housing 110, if desired.

Drawer (with handle) 300 is slidably housed within the bottom recess of housing 110 to permit the user to advantageously (with maximum ease and comfort) retract and return drawer 300; specifically, to mount model 405 (before thermoforming), adjust and manipulate model 405 as desired, and later (after thermoforming) withdraw model 405. An example of advantage of this “open” configuration is where model 405 is a dental retainer that requires, all in a very short period of time, operator placement of wires thereto and the application of acrylic resin, and then adjustment thereof to ensure that it is sitting flat on fluid-like model-retaining material like pellets.

Drawer 300 may be slidably suspended conventionally by longitudinal guides (not shown) to permit simple guided insertion into and withdrawal from within housing 110, with the longitudinal guides secured to the internal sides of housing 110 for cooperation with corresponding roller or slide guides (not shown) of drawer 300.

As shown in FIGS. 1-3 and 6, drawer 300 has base 210 rigidly secured therein, that has an annular upright shoulder 530 forming a recessed area for snug placement of work table 400 therewithin, all centered around the central axis. Work table 400 is circular and foraminous, perforated or is otherwise profiled (e.g. porous aluminum 401) to have a plurality of holes that permit the (forced or vacuumed) passage of air therethrough. Alternatively (not shown), instead of work table 400, the recessed area formed by shoulder 530, holds a fluid-like model-retaining material (such as lead pellets/shots well known in the industry).

The position of drawer 300 retracted from housing 110 is the “mechanically open—thermoforming inoperative” position. After mounting model 405 within drawer 300 (as explained below), drawer 300 is slid back into housing 110 to be ready for the thermoforming process (explained below)—this is the “mechanically closed—thermoforming operative” position. Unless drawer 300 is completely and properly in this position, the thermoforming process cannot proceed or continue. A micro-switch or similar conventional mechanism (not shown) is provided at the appropriate location relative to drawer 300 and within the bottom recess of housing 110 to signal when drawer 300 is properly in place in the “mechanically closed—thermoforming operative” position. This signal is used to permit the thermoforming process to start/continue and also could be used to light a visual or aural indicator that such a position has been achieved.

Before the thermoforming process, the operator performs three preparatory steps, next.

As a first preparatory step, drawer 300 is retracted and model 405 is placed by the operator on work table 400, and returned into housing 110 into the “thermoforming operative” position of drawer 300. In that position, work table 400, and model 405, is positioned directly on the vertical axis of plunger 201.

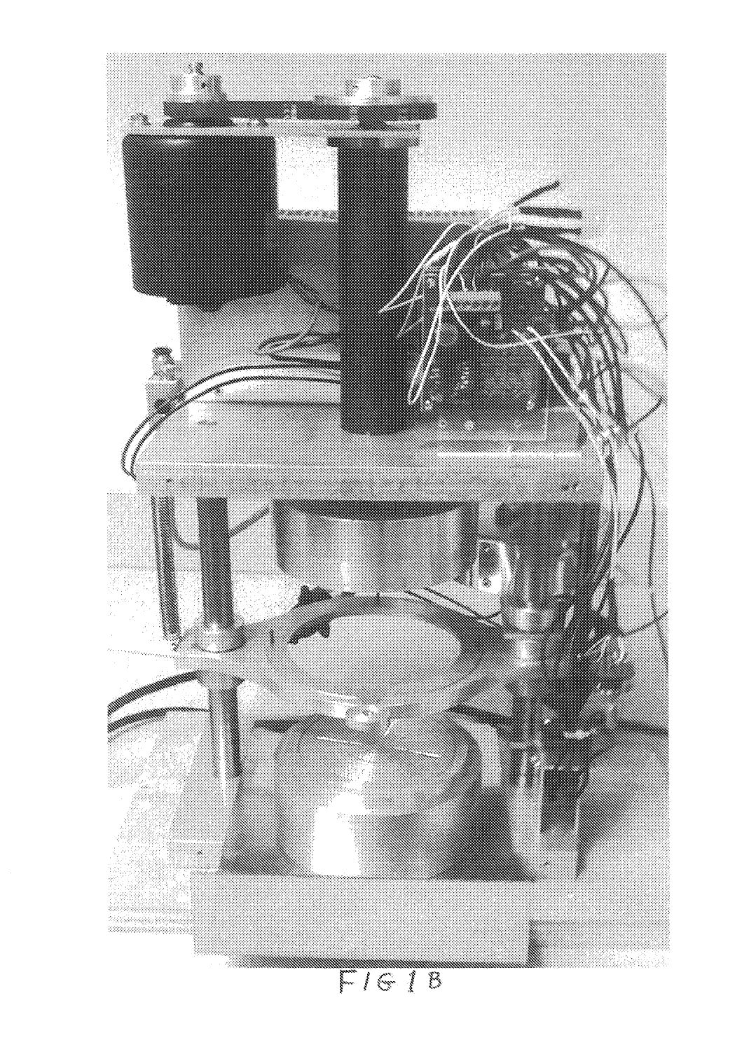

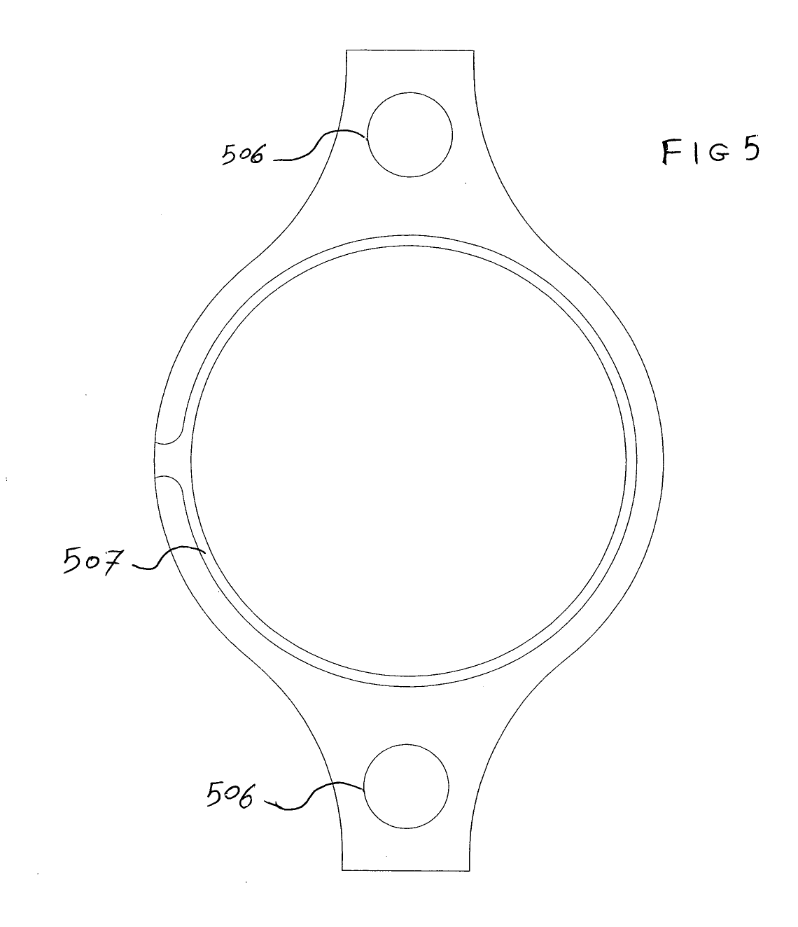

The annular exterior of shoulder 530 is beveled to accept a complementarily beveled base 508 of tray 500 when fitted within carriage 505 for a tight mechanical fit therebetween (as seen in FIGS. 2 and 5). This complementary construction makes the combination of work table 400, tray 500 and carriage 505 to be self-aligning vertically along the main central vertical axis of thermoformer 100.

Retaining material or blank 410 is a thermoforming material that is suitable for the application involving the subject model 405. Blank 410 can be of a single layer of material. Advantageously, blank 410 may be made of two layers (commonly called “dual laminates”), which is a “soft layer” and a “hard layer” (with the result that, after thermoforming, the “soft layer” gently contacts the patient's gum whereas the “hard layer” faces advantageously “outwardly” from the patient's teeth since it is resistant to grinding and more suitable for doing further work on.

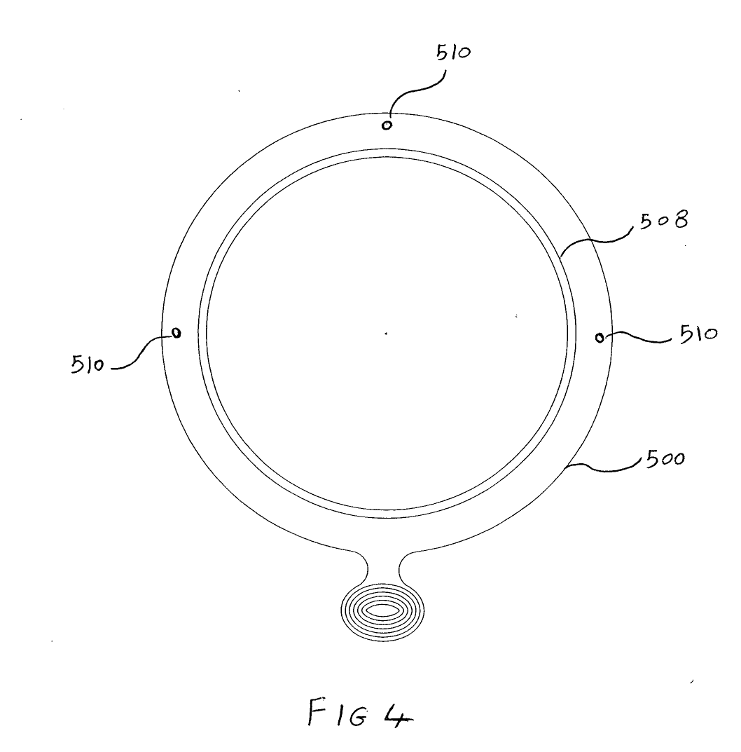

As the second preparatory step, blank 410 is placed and aligned on ring tray 500 by the operator. As seen in FIG. 4, blank 410 may be square (not shown) or circular (shown), and its alignment on tray 500 is assisted by three circumferential guide pins 510 that extend upwardly from the upper surface of tray 500 at three locations to accept and hold in place blank 410. Tray 500 is profiled to fit snugly within internal annular recess or cradle 507 of carriage 505 so that the upper surface of tray 500 is flush with the upper surface of carriage 505 when fitted in recess 507. It is noteworthy that no gaskets or other securing mechanism is needed to secure blank 410. It is noteworthy that in case blank 410 is a “dual laminate”, the operator places blank 410 on tray 500 with the “hard layer” facing upwards, and the “soft layer” facing downwards, and that no further manipulation of blank 410 is necessary—the thermoforming process, explained below, will bring the “soft layer” of dual laminate blank 410 into contact with model 405.

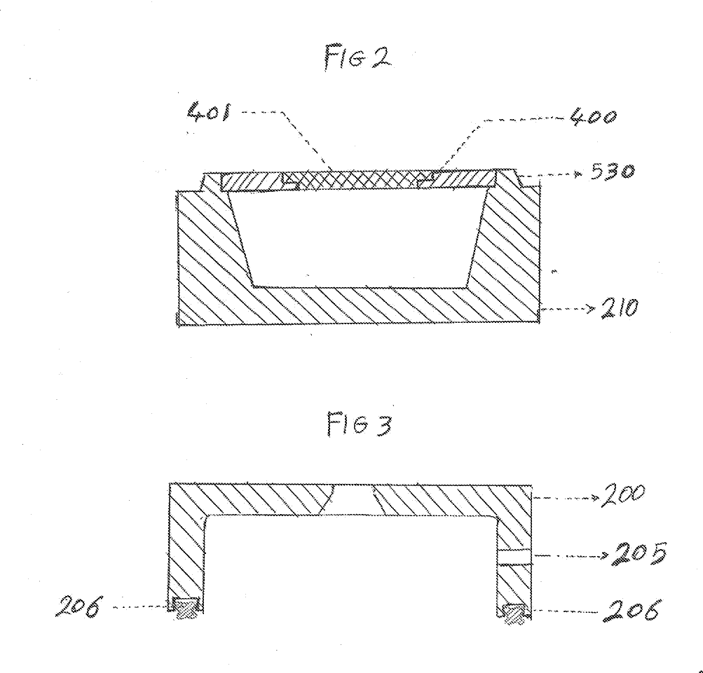

As seen in FIGS. 1 and 6, cover 200 is actuated vertically by plunger 201, and normally is in its first, vertical rest position located axially above tray 500. Plunger 201 is basically a jack screw actuated by a conventional DC motor and belt configuration (explained in more detail below). As seen in FIG. 3, cover 200 has forced air inlet 205 on the periphery which is in conventional communication (e.g. tube, not shown) with a conventional forced or compressed air source (not shown, whether disposed within or without housing 110) that is capable of delivering adequate pressure (for example, in the order of 30 to 150 psi for most dental model applications). The circumferential bottom of cover 200 has an annular channel housing a conventional Q-ring or X-ring 206. Cover 200's outer diameter fits within the semi-circle circumscribed by three tray guide pins 510.

Ring carriage 505 has two opposed, peripheral holes 506 on either side of the central cavity, that cooperate with two associated identical vertical posts 520 of housing 110 that each act as vertical supports/guides/bearing ways for carriage 505 in its vertical movements, as explained below. One post 520 (as shown in FIG. 1) also acts as the support frame for heating unit 250 and spring 600, as explained below.

The combination of blank 410 on tray 500 being carried by carriage 505, is kept in its first, resting vertical position by tension springs 600. Tension springs 600 may be conventionally attached at their respective upper ends to their respectively proximate posts 520 or (not shown) other appropriate housing 110 frame component, and at their lower ends to the top of carriage 505 proximate their respective holes 506. Thus configured, springs 600 urge carriage 505 upwardly against a bushing or similar stop on post 520 being its first, resting vertical position. Carriage 505 is thus a “floating platform” and so can be lowered (from its first, resting position) and raised (from its second, “chamber” position, explained below) by the action of the said combination of plunger 201 and cover 200, and otherwise, retains its vertical position “by itself” without intermediate steps (such as additional mechanical locks or locking steps).

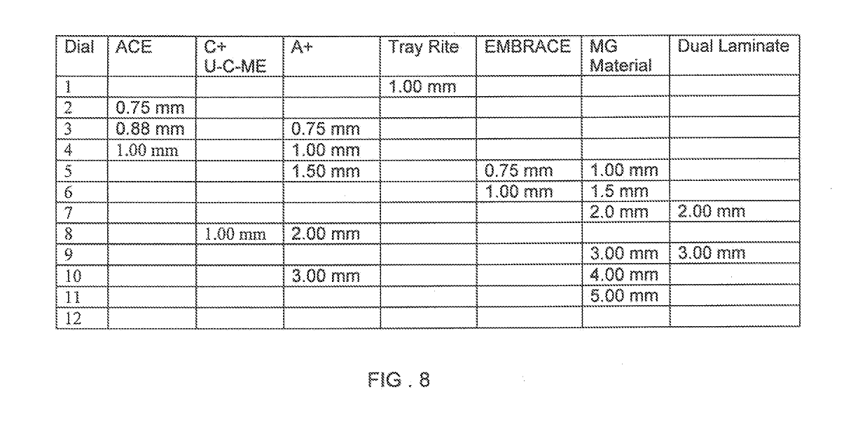

As a third preparatory step, the operator turns dial 111 to select the setting indicated by the chart of FIG. 8, as being appropriate for the material and thickness of subject blank 410, and the relevant dental application (and where the material is identified by trade-name or the like, the application is implied by thereby). The selected setting sets the prescribed duration period of the first step of the thermoforming process (heating blank 410, explained below). The duration of the other steps of thermoforming (i.e. actuating cover 200 to eventually form the chamber about model 405 and then forcing air into the chamber to impress heated and softened blank 410 into model 405) are prescribed and fixed once the actuation mechanism and forced air source are determined and employed and is not operator-influenced. The prescribed duration of the first thermoforming step of heating blank 410 is based on an estimate derived from prior experimentation parameterized by a number of factors including the performance particulars of the employed heating unit 250, of various models 405 and applications, and of blanks 410 of various materials and thicknesses; and by assumptions (the main one being the ambient temperature, especially that of the interior of heating unit 250). The prescribed duration of heating blank 410 can be overridden by direct temperature measurement, as explained below, in connection with a variation of the present embodiment.

After these preparatory steps (of mounting model 405 on work table 400; placing blank 410 on tray 500, and then tray 500 on carriage 505; selecting the prescribed duration for the subject blank 410), no other step or calculations are required of the operator. Once the operator engages dial 111 to start the thermoforming process, each thermoforming step is performed automatically, with each step lasting the prescribed duration of thermoforming according to the selection. The following thermoforming steps are automatically performed (by means of conventional actuation and timing mechanisms).

As a first step of thermoforming, as seen in FIG. 1, heating unit 250 is rotated from its resting, horizontal position (outside the periphery of the main central axis) into a position directly over blank 410 on carriage 505 (that is in its said first, resting vertical position). Heating unit 250 is activated and heats blank 410 for the prescribed duration (according to operator selection via dial 111). Heating unit 250 then is rotated out of the way to return to its resting, horizontal position. The result is a suitably heated and softened blank 410 which is ready for impression on model 405. Then begins automatically the second thermoforming step (explained below) by a conventional mechanism (such as a micro-switch and/or a timer circuit).

Heating unit 250 is conventionally connected to post 520 and is aforesaid rotatable by conventional actuation mechanisms (e.g. jointed-arm articulated movement whose articulated arms retract and expand in a “frog-like” motion to bring or rotate heating unit 250 from its rest position and returns to its rest position).

As a second step of thermoforming, plunger 201 is actuated downwardly so that cover 200 is lowered downwardly with enough force to engage carriage 505 (with tray 500-blank 410) at its first, upper vertical position. There is no gasket or any need to otherwise frame blank 410, as in other prior art devices. The contact between cover 200, blank 410 on tray 500, is a simple vertical abutment and sandwiching. The combination of cover 200, blank 410 on tray 500 and carriage 505) continues downwardly (actuated by plunger 201) until carriage 505 mates with shoulder 530 of base 210 to create an air-tight chamber with chamber base 210 (at which time, plunger 201 stops its downward actuation triggered by conventional mechanisms such as an appropriately located micro-switch). The achievement of this second, “chamber” position of carriage 505 means that chambered model 405 is ready for the next step.

As a third step of thermoforming, forced air is injected into the chamber through inlet 205 for the prescribed duration. The forced air forms (the heated and softened) blank 410 over the contours of model 405. After the prescribed duration, chamber cover 200 is lifted by rising plunger 201, thus permitting carriage 505 to return to its first resting vertical position by the upward urging of tension springs 600. What remains on tray 500 is model 405 with blank 410 impressed thereon and now a formed (pre-finished) appliance that is ready for removal by the operator.

Actuation (for the vertical movement of cover 200 by plunger 201 and for the rotation of heating unit 250) is achieved by a primary electric motor, and one or more secondary electric motors, imparting motion through the agency of conventional belt-gear-shaft-screw-re-circulating nut mechanisms, all of which cooperate conventionally to translate radial or rotary motion into various horizontal (retract/extend) and vertical motions and vice-versa. The primary electric motor may be a conventional 12 volt DC, 8-12 amps electric motor that can provide enough torque, via the aforesaid agency, to turn screw jack and vertically actuate plunger 201.

A large downward turn (2-5 tons pressure is desired at the circle of contact between Q-ring 206 and carriage 505) is required to form the aforedescribed pressure chamber (of cover 200 and base 210 with carriage 505/tray 500 therebetween) but only a relatively light turn is required on the upward return of screw jack plunger 201. A configuration for screw jack plunger 201 is shown in FIG. 6, where conventional rotational bearings 710 provide rotational assistance to screw jack turning and conventional thrust bearings 714 provide high axial load.

Heating unit 250 may have an infra-red halogen lamp or other suitable an electrical resistance radiant heater, or a heater from the group consisting of an infrared, microwave and ultrasonic heater.

Calibration of heating unit 250 is provided by adjusting the timing (for example, with a potentiometer cooperating with a conventional L-R-C timing circuit). Calibration would be useful in response to ambient environmental conditions (e.g. in a hot, desert-like environment, the prescribed duration periods of heating by heating unit 250 may be shortened relative to those settings for cooler locations). Calibration would also be useful for new materials for blank 410 which have different heating characteristics than those commonly used now.

As an alternative (not shown) to heating unit 250, cover 200 may be fitted internally with a suitable heater. For example, an ultrasonic heater (of capability suitable for the subject blank 410 and model 405 application) is positioned centrally within cover 200 such that when cover 200 is lowered, the ultrasonic heater is very proximate or contacting blank 410. This obviates the need for discrete heating unit 250 and associated mechanical supports.

The prescribed durations (of the thermoforming steps described above and which form the basis of the timing chart of FIG. 8) are based on the assumption that certain key structural components (e.g. the interior of heating unit 250 and the interior of cover 200) are at a (known and set) ambient temperature when the thermoforming steps are begun. If the thermoforming process is not repeated in rapid succession for a plurality of blanks 410 and models 405, i.e. sufficient time elapses for cover 200 and heating unit 250 to return naturally to their ambient temperature, there is no need for any “pro-active” cooling. But in a busy, “conveyor-belt”-like work situation where many models 405 and blanks 410 are processed by thermoforming in a short time, cover 200 (especially when fitted internally with a heater) and/or heating unit 250 may need “pro-active” cooling.

Accordingly, a proximate, small conventional cooling fan (not shown) may be directed to the interior of cover 200 and initiated automatically upon return of cover 200 to its first, vertical rest position after the thermoforming steps have been performed, so as to cool the interior to the ambient temperature that is assumed by the timing chart of FIG. 8. Accordingly, a proximate, small conventional cooling fan (not shown) may be directed to the interior of heating unit 250 and initiated automatically, upon return of heating unit 250 to its rest position after heating blank 410, to cool the interior of unit 250 to the ambient temperature assumed by the timing chart of FIG. 8.

In a juke-box like method (not shown), blanks 410 of several different materials can be stored in a magazine arrangement and there is provided a conventional selection and conveying mechanism between magazine and tray 500 for more convenient processing of blanks. With a conventional, mechanical “conveyor belt” system, multiple models 405 can be thermoformed employing the teachings of the present invention.

For more temperature sensitive processing, a conventional infrared thermostat (not shown) measures the temperature of blank 410 and stops heating unit 250 upon reaching a set temperature, which in effect overrides the default timing as set by the selection process initiated by engaging dial 111 according to the timing chart of FIG. 8.

Some prior art devices require the operator to manually flip a “dual laminate” blank 410 after heating the “hard” layer. It is apparent that for thermoformer 100, it suffices that a “dual laminate” blank 410 be placed on tray 500 with the “hard” layer facing upwardly (for more direct reception of the heating of heating unit 250), and no further operator manipulation is required.

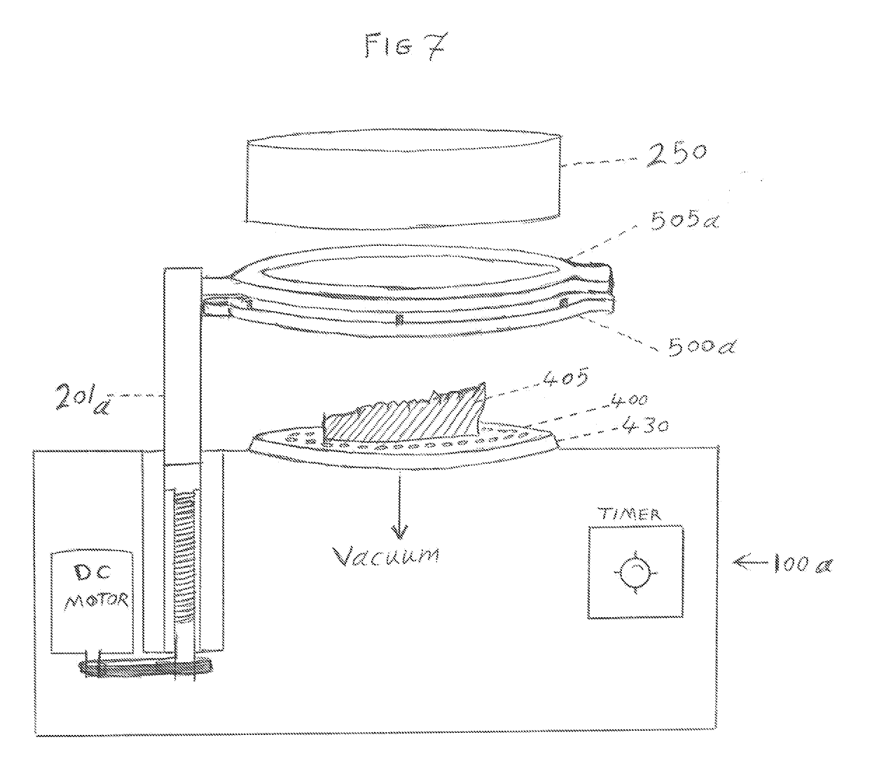

Instead of forced air (as used in the embodiment of FIGS. 1-6), a vacuum embodiment, thermoformer 100a as shown in FIG. 7, employs many of the basic techniques described above for the “forced air” embodiment.

Thermoformer 100a has a central vertical axis and a corresponding columnar space where the main activity is carried out. In thermoformer 100a, work table 400 snugly fit within a base with beveled shoulder 530, and model 405 mounted on work table 400, are as above for thermoformer 100 but are rigidly disposed atop of housing 110a (i.e. without slidable drawer 300). A conventional vacuum pump is provided below work table 400. For most dental applications, this conventional vacuum pump need not have more suction power than that found in a typical consumer home vacuum cleaner and in fact, such a vacuum cleaner can be used to provide the necessary vacuum with a simple attachment to thermoformer 100a.

Heating unit 250 is as described above but disposed (without any need or means for rotational or vertical movement) on the central working axis above work table 400.

Tray 500a is similar to tray 500 except that instead of guide pins 510, or in addition to guide pins 510, there are disposed, on the upper surface of tray 500a, a plurality of magnets (not shown). Tray 500a serves as the “bottom ring” that cooperates with carriage 505a that serves as the “upper ring”, to securely (but easily separably manually) sandwich blank 410 therebetween. Carriage 505a is similar to carriage 505 in being a ring but optionally has magnets (not shown) to cooperate with the magnets of tray 500a to provide a secure sandwiching of blank 410 between carriage 505a and tray 500a.

Carriage 505a is attached to actuator 201a that operates vertically beside carriage 505a. Actuator 201a can be a screw jack that does not need to be as powerful as plunger 201. It needs to provide only enough torque to move vertically the combination of tray 500a and carriage 505a and its light load of blank 410, and can be actuated by a conventional DC motor and belt configuration imparting radial motion to the screw jack of actuator 201a.

The thermoforming process for thermoformer 100a adopts some of the principles employed for thermoformer 100 in that the thermoforming steps are automated by employing prescribed durations based on a selection parameterized by the material and thickness of subject blank 410, and the relevant dental application (i.e. based on a chart like FIG. 8). Heating unit 250 is initiated for the prescribed duration. Then actuator 201a lowers the combination of carriage 505a, tray 500a and heated and softened blank 410 on tray 500a, until tray 500a mates with the beveled shoulder 530 of the base which holds work table 400. The vacuum (operable from below work table 400) is then initiated automatically (for example, by a micro-switch that triggers on the beveled-mating of carriage 505a and shoulder 530), and thereby blank 410 is sucked downward to form over model 405, for the prescribed duration. The result is a formed (pre-finished) appliance that is ready for removal by the operator.

The prescribed durations of the thermoforming steps of thermoformer 100a may be similar to those of thermoformer 100. The prescribed duration of the third thermoforming step (forced air/vacuum) may differ—depending on the strength of the vacuum, the blank heating step may be longer or shorter than their corresponding duration for thermoformer 100.

Material for housing 110, drawer 300, work table 400, tray 500, carriage 505 and the other aforedescribed components are aluminum and/or steel of appropriate grade. Housing 110 can have a base of 36 cm by 27 cm and height of 63 cm, for easy fit on standard lab benches.

Blank 410 may be a thermoplastic (common examples include copolyester, polypropylene/ethylene copolymer and polyethylene) that softens typically in a range of about 70 to 200 degrees Centigrade. Single layer blank 410 are typically about 0.5 to 5 mm thick, and “dual laminates” are about 2 to 3 mm thick. Commercially available blanks include those identified in the chart of FIG. 8.

Model 405 in the above description can be any male entity from which can be thermoformed any dental appliance like dental retainer, mouth & night guards, splints, custom impression trays, base plates, temporary crowns & bridges, orthodontic appliances, snore guards, bleach trays, temporary dentures, surgical stents for implants and model duplications. Non-dental examples include components for ear-aids and similar prosthetic devices.

An alternative to tension spring 600, is a compression spring located under carriage 505 that urges upwardly carriage 505 against a bushing on post 520 and in a resting, vertical position that corresponds to the equivalent position of carriage 505 described above in connection with FIGS. 1-6.

Although magnets are described in conjunction with thermoformer 100a for the combination of carriage 505a and tray 500a, any conventional mechanism for the easy, separable and gasket-less securing of blank 410 may be used. For example, carriage 505a and tray 500a are hingedly configured with a manual lock or fastener that is engaged upon loading blank 410 therebetween.

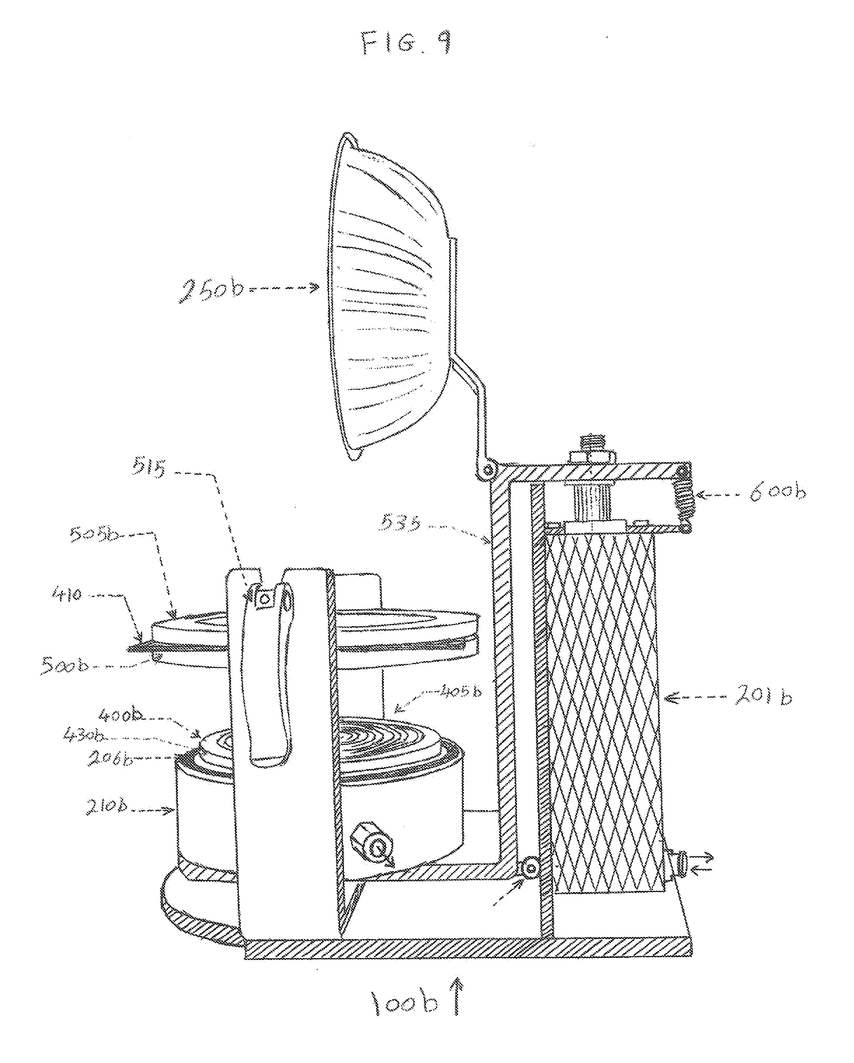

Instead of forced air (as used in the embodiment of FIGS. 1-6), a vacuum/compressor embodiment is shown in FIG. 9. Thermoformer 100b employs many of the basic techniques described above for the “forced air” embodiment.

Thermoformer 100b has a central vertical axis and a corresponding columnar space where the main activity is carried out. In thermoformer 100b, work table 400b snugly fits within a base 210b with beveled shoulder 430b, and die or model 405b (whose position is shown notionally in FIG. 9) mounted on work table 400b, and are as above for thermoformer 100, but are rigidly attached to lift frame 535 (described below). A conventional vacuum/compressor (not shown in FIG. 9) is provided and for most dental applications, such a vacuum/compressor provides enough suction power to create a vacuum within base 210b and enough compression power to actuate pneumatic cylinder or actuator 201b.

Heating unit 250b is as described above (for heating unit 250). Heating unit 250b is lowered by the operator from a vertical (“heat off”) position to a horizontal (“heat on”) position that aligns it on the central working axis above work table 400b and blank 410.

Tray 500b is similar to tray 500 in having guide pins (not shown in FIG. 9 but are explained above about pins 510). Tray 500b is rigidly fixed to side posts that extend vertically to support activity in the columnar space about thermoformer 100b central axis (being a simpler version of posts 520 of the “forced air” embodiment). There are disposed: (1) a ring 505b that serves as the “upper ring”, (2) tray 500b that serves as the “bottom ring” that cooperates with “upper ring” 505b, and (3) a conventional, quick release type clamping mechanism 515, proximate the periphery of ring 505b and tray 500b that securely (but easily separably manually) sandwiches blank 410 between the two rings by pressing vertically ring 505b to tray 500b. Holder 505b is similar to carriage 505 in being a ring but additionally has clamping mechanism 515 that cooperates with the side posts to provide a secure sandwiching of blank 410 between ring 505b and tray 500b.

Base 210b is attached to vertically oriented pneumatic actuator 201b through the rigid agency of lift frame 535. Actuator 201b does not need to be as powerful as plunger 201 in the “forced air” embodiment. It needs to provide only enough torque to move vertically the combination of base 210b and work table 400b and its load of model 405b, and can be actuated by the same conventional vacuum/compressor that at the same time automatically returns heating unit 250b to “heat off” position. Lift frame 535 rigidly supports base 210b and associated parts described above and is actuated vertically by actuator 201b (with conventional guide and support mechanisms not show for simplicity).

The thermoforming process for thermoformer 100b adopts some of the principles employed for thermoformer 100 in that the thermoforming steps are automated by employing prescribed durations based on a selection parameterized by the material and thickness of blank 410, and the relevant dental application (i.e. based on a chart like FIG. 8). Heating unit 250b is initiated for the prescribed duration to heat and soften blank 410 on tray 500b. Then actuator 201b moves up (through the mechanical agency of frame 533) the combination of base 210b, work table 400b and model 405b, from its initial rest position, towards heated and softened blank 410 on tray 500b, until tray 500b mates with the O ring 206b of the base 210b which holds work table 400b. The vacuum (operable from below work table 400b) is then initiated automatically (e.g. by a conventional relay timer, not shown) at the end of heating time cycle, and thereby softened blank 410 is sucked downward to form over model 405b, for the prescribed duration. Then actuator 201b, assisted by loaded spring 600b connecting the body and the shaft of the actuator 201b, moves back down and lowers base 210b to its rest position. The result is a formed (pre-finished) appliance that is ready for removal by the operator.

Because all thermoforming steps are automated and parameterized by duration, implementation can be effected completely by simple conventional (e.g. R-C (resistor-capacitor)) timing circuits instead of more sophisticated and expensive technology like a microprocessor.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “top”, “bottom”, “first”, “second”, “inside”, “outside”, “edge”, “side”, “front”, “back”, “length”, “width”, “inner”, “outer”, and similar terms are used herein, it should be understood that these terms have reference only to the structure shown in the drawings as it would appear to a person viewing the drawings and are utilized only to facilitate describing the invention.

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

The Abstract of the Disclosure is provided to comply with the legal requirement for an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A device for thermoforming a dental model, comprising:
a) a base on which the model is mounted;
b) a thermoplastic blank;
c) a platform that holds said blank and is suspended in a first position;
d) a heater that locates itself above said blank to heat said blank, and then moves away;
e) a vertical cover that automatically moves downwardly to engage said blank on said tray and engages said base to form an air-tight chamber about the model; and
f) forced air source connected to said air-tight chamber.

2. A method of thermoforming a dental model, comprising the steps of:
a) mounting a model on a base;
b) placing a thermoplastic blank on a tray;
c) automatically heating said blank for a prescribed duration that is suitable for the said blank and model;
d) locating said heated blank above the model;
e) applying forced air to form said heated blank over the contours of the model.
